(19) United States
(12) Patent Application Publication
(10) Pub. No.: US 2026/0166575 A1
(43) Pub. Date: Jun. 18, 2026

(54) SPRAYING DEVICE AND SPRAYING METHOD

(71) Applicant: Industrial Technology Research Institute, Hsinchu (TW)

(72) Inventors: Chun-Chieh Huang, Hsinchu City (TW); Wann-Hsin Chen, Hsinchu City (TW); Hung-Chih Chiang, Chiayi City (TW); Wan Hsun Lo, Taichung City (TW); Ching-Mei Chen, Tainan City (TW); Mang Ou Yang, Hsinchu City (TW); Chi-Shen Chang, Hsinchu County (TW)

(73) Assignee: Industrial Technology Research Institute, Hsinchu (TW)

(21) Appl. No.: 18/991,676

(22) Filed: Dec. 22, 2024

(30) Foreign Application Priority Data
Dec. 17, 2024 (TW) 113149123

(51) Int. Cl. B05B 7/24; B05B 7/10

(52) U.S. Cl. CPC B05B 7/2491; B05B 7/10

(57) ABSTRACT

Provided are a spraying device and a spraying method. The spraying device configured to spray a liquid onto a region to be sprayed includes a gas pressure source, a spraying head and a pipe unit. The spraying head is adapted to spray the liquid in an annular pattern. The pipe unit is connected between the gas pressure source and the spraying head for providing the liquid into the spraying head. When the liquid is located in the pipe unit, the gas pressure source provides a first gas pressure to transport the liquid located in the pipe unit to the spraying head. When the liquid reaches to the spraying head, the gas pressure source provides a second gas pressure to spray the liquid in the annular pattern through the spraying head onto the region to be sprayed.

### CROSS-REFERENCE TO RELATED APPLICATION

This application claims the priority benefit of Taiwan application serial no. 113149123, filed on Dec. 17, 2024. The entirety of the above-mentioned patent application is hereby incorporated by reference herein and made a part of this specification.

### TECHNICAL FIELD

The disclosure relates to a device and a method, and in particular to a spraying device and a spraying method.

### BACKGROUND

An endoscope is a medical instrument that enters the human body through various natural orifices in the human body for the purpose of observing the internal conditions of the human body. When the inspection and surgery are performed through the endoscope, only a small area of damage may be caused to the human body, but the same purpose may be achieved as the surgery in the past, allowing the endoscope to be an inspection tool that has been commonly used in modern medical treatment. The gastrointestinal tract, respiratory tract, urinary tract, female reproductive system, abdominal cavity, joint cavity, chest cavity, etc. are all in the scope of application of the endoscope. In addition, the minimally invasive surgery is also in the scope where the endoscope is commonly used. Minimally invasive surgeries that need to apply the endoscopes may include the spine, nasal cavity, brain, etc.

Through the examination of the endoscope, some fine wounds inside the human body might only need to be treated by spraying medicines or using methods such as spraying cells, and do not need to perform an endoscopic surgery. After some endoscopic surgeries, the affected part needs to be sprayed with medicines or sprayed with cells, etc. to accelerate the recovery of the affected part.

Therefore, the spraying coverage rate of the medicines on the affected part, the quantity and survival rate, etc. of the cells after being sprayed to the affected part all need to be taken in consideration to improve the therapeutic effect.

### SUMMARY

The disclosure provides a spraying device, which has a good medicine spraying coverage rate and a good cell survival rate.

The disclosure provides a spraying method which enhances a spraying effect.

A spraying device of the disclosure is for spraying a liquid on a region to be sprayed. The spraying device includes a gas pressure source, a spraying head, and a pipe unit. The spraying head is adapted to spray the liquid in an annular pattern. The pipe unit is connected between the gas pressure source and the spraying head for providing the liquid into the spraying head. When the liquid is located in the pipe unit, the gas pressure source provides a first gas pressure to transport the liquid located in the pipe unit to the spraying head. When the liquid is moved to the spraying head, the gas pressure source provides a second gas pressure to spray the liquid in the annular pattern through the spraying head to the region to be sprayed.

In an embodiment, the spraying head includes a first swirl chamber, a fluid outlet, a second swirl chamber, and a turbine. The first swirl chamber is in communicating with the pipe unit. The second swirl chamber is positioned between the first swirl chamber and the fluid outlet. The turbine is disposed within the first swirl chamber.

In an embodiment, a ratio of a diameter of the fluid outlet to a total length of the first swirl chamber and the second swirl chamber is between 0.4 and 1.

In an embodiment, a ratio of a curvature of an opening of a spiral groove of the turbine to a curvature of a spiral part of the turbine is between 1 and 5.0.

In an embodiment, the spraying device further includes a non-return valve disposed at an end of the spraying head relatively close to the pipe unit. The non-return valve is located between the turbine and the pipe unit.

In an embodiment, an opening and a closing of the non-return valve are linked to the gas pressure source.

In an embodiment, a pressure value of the first gas pressure is less than a pressure value of the second gas pressure.

In an embodiment, the pressure value of the first gas pressure is between 0 and 10 kPa, and the pressure value of the second gas pressure is between 50 to 200 KPa.

In an embodiment, the liquid contains cells or medicines.

In an embodiment, the spraying device further includes a tube joint. The pipe unit includes a first tube and a second tube. The first tube is in communicating with the gas pressure source. The second tube is connected to the spraying head. The tube joint is communicated between the first tube and the second tube. The liquid is adapted to enter the pipe unit through the tube joint.

In an embodiment, the tube joint is a three-way tube or a directional valve.

A spraying method adapted to spray a liquid on a region to be sprayed at least includes the following steps: the foregoing spraying device is provided; a liquid is injected into the pipe unit; when the liquid is located in the pipe unit, the gas pressure source provides a first gas pressure to transport the liquid located in the pipe unit to the spraying head; and once the liquid is moved to the spraying head, the gas pressure source provides a second gas pressure to spray the liquid in an annular pattern through the spraying head to the region to be sprayed.

In an embodiment, an amount of the liquid injected into the pipe unit is 0.1 to 2 ml.

In an embodiment, a pressure value of the first gas pressure is less than a pressure value of the second gas pressure.

In an embodiment, the pressure value of the first gas pressure is between 0 and 10 kPa, and the pressure value of the second gas pressure is between 50 and 200 kPa.

In an embodiment, the liquid contains cells or medicines.

In an embodiment, the spraying method further includes disposing a non-return valve at an end of the spraying head proximal to the pipe unit. The non-return valve is located between a turbine of the spraying head and the pipe unit to prevent the liquid from flowing back into the pipeline.

In an embodiment, an opening and a closing of the non-return valve are linked to the gas pressure source.

Based on the above, the disclosure provides the spraying device with a novel structure, which is capable of achieving a high medicine spraying coverage and cell survival rate, and the spraying method implemented through the spraying device can enhance the spraying effect.

### BRIEF DESCRIPTION OF THE DRAWINGS

FIG. 1 is a schematic view of a spraying device according to an embodiment of the disclosure.

FIG. 2A is a schematic cross-sectional view of the spraying head in the spraying device and the endoscope shown in FIG. 1 in an inner annular wall.

FIG. 2B is a perspective schematic view of another viewing angle of the spraying head in FIG. 2A.

FIG. 2C is a partial side view of the turbine shown in FIG. 2B.

FIG. 2D is a cross-sectional view of the turbine shown in FIG. 2C.

FIG. 3A is a schematic view of a spraying head further provided with a non-return valve.

FIG. 3B is a schematic view of a deformation of a non-return valve caused by a gas pressure source pumping a gas.

FIG. 4A to FIG. 4C are schematic views of using the spraying device shown in FIG. 1 to implement a spraying method.

FIG. 5 is a comparison of a diagram of a spraying profile which is sprayed by the spraying device shown in FIG. 1 of the disclosure and a diagram of a spraying profile which is sprayed without using the spraying device of the disclosure.

FIG. 6A is a comparative schematic view of survival rates of cells after being sprayed with different high-pressure gases according to an embodiment of the disclosure.

FIG. 6B is a comparative schematic view of recovery rates of cells after being sprayed with different high-pressure gases according to an embodiment of the disclosure.

FIG. 6C is a schematic view of survival rates of cells after being sprayed and cultured according to an embodiment of the disclosure.

### DETAILED DESCRIPTION OF DISCLOSURED EMBODIMENTS

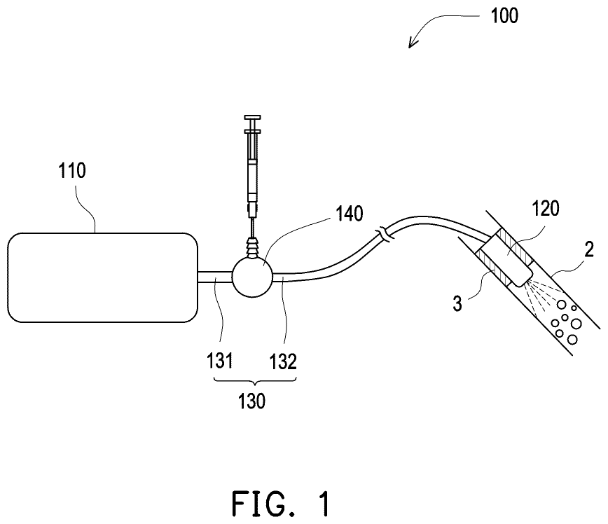

FIG. 1 is a schematic view of a spraying device according to an embodiment of the disclosure. Please refer to FIG. 1. A spraying device 100 of the embodiment may be integrated into an endoscope 3 to serve as an auxiliary medical device for the endoscope 3. Specifically, when the endoscope 3 is used to inspect the internal organs of the human body such as the trachea, esophagus, lungs, intestines, stomach, the endoscope 3 is used to observe the internal part of the human body having fine wounds, spots of inflammation or spots where the stem cell treatment needs to be performed. A liquid may be sprayed on a region to be sprayed (also known as an affected part) through the spraying device 100 to perform a simple treatment procedure. Alternately, after some endoscopic surgeries, medicine or cells, etc. may be sprayed on the affected part to accelerate the recovery of the affected part. The liquid sprayed through the spraying device 100 may contain medicines or cells (such as mesenchymal stem cells, MSCs) according to actual treatment needs. This type of treatment replaces the type of medical treatment such as swallowing pills that reduce inflammation, stop bleeding, or facilitate wound healing. Specifically, the affected part may be located on an inner annular wall 2 of a biological tissue, such as a trachea, but the disclosure is not limited thereto. The embodiment takes the spraying device 100 for spraying a liquid to the affected part of the inner annular wall 2 as an example for illustration. The spraying device 100 of the embodiment sprays a liquid that contains medicines or cells in an annular pattern to the affected part located on the inner annular wall 2. The spraying device 100 may spray out the cells or the medicines injected therein as much as possible, effectively decreasing the liquid remaining on the inside of the spraying device 100, and may effectively control the dosage or cell volume of each treatment, improving the dose that accurately enters the treatment tissue.

Based on the above, the spraying device 100 of the embodiment includes a gas pressure source 110, a spraying head 120, and a pipe unit 130.

The pipe unit 130 is connected between the gas pressure source 110 and the spraying head 120. The pipe unit 130 is configured to provide the liquid to the spraying head 120. The gas pressure source 110 is configured to supply a gas into the pipe unit 130 to propel the liquid in the pipe unit 130 toward the spraying head 120 and then spray out in a type of an annular spray pattern from the spraying head 120.

Specifically, the pipe unit 130 includes a first tube 131 and a second tube 132. The first tube 131 is connected to the gas pressure source 110, and the second tube 132 is connected to the spraying head 120. In order to allow the liquid to enter the pipe unit 130, the spraying device 100 further includes a tube joint 140 positioned on the pipe unit 130 and in communicating with the pipe unit 130. The tube joint 140 is connected between the first tube 131 and the second tube 132. The tube joint 140 may be a three-way tube or a directional valve. Through the disposal of the tube joint 140, the liquid may enter into the pipe unit 130 through the tube joint 140.

Please continue to refer to FIG. 1. The foregoing gas pressure source 110 may be a pump or a compressed gas source. The gas pressure provided may be adjusted based on the location of the liquid. Specifically, the gas pressure source 110 of the embodiment may provide a first gas pressure or a second gas pressure at an appropriate occasion in a manner where a microchip controls the pump. In other embodiments, the first gas pressure and the second gas pressure may be provided in other manners. For example, in an embodiment, the first gas pressure may be formed by a syringe injecting a gas from the tube joint 140, and the second gas pressure is provided by a microchip controlling the gas pressure source 110. In another embodiment, the first gas pressure may be formed by a syringe injecting a gas from the tube joint 140, and the second gas pressure is provided by a compressed air passing through a pressure limiting valve. In another embodiment, the first gas pressure and the second gas pressure may also be generated by a compressed air passing through a pressure limiting valve.

Based on the above, according to the embodiment, when the liquid is positioned within the second tube 132, a pressure value of the first gas pressure provided by the gas pressure source 110 is lower than a pressure value of the second gas pressure provided by the gas pressure source 110 when the liquid is positioned within the spraying head 120.

Specifically, after the liquid enters the pipe unit 130 through the tube joint 140, the gas pressure source 110 supplies the first gas pressure to the pipe unit 130 to propel the liquid entering the pipe unit 130 toward the direction of the spraying head 120 into the second tube 132. Considering that the liquid may contain medicines or cells, a low-pressure gas is used to allow the liquid in the second tube 132 to move as slowly as possible to prevent the cells from forming a shearing force with the tube wall of the second tube 132 and destroying the cells. On the contrary, when the liquid is located at the spraying head 120, since the liquid needs to be quickly sprayed out through the spraying head 120, the gas pressure source 110 provides the second gas pressure to quickly spray out the liquid at this time, and the liquid that is sprayed out is sprayed in an annular pattern. In an embodiment, the pressure value of the first gas pressure is between 0 and 10 kPa, and the pressure value of the second gas pressure ranges from 50 and 200 Kpa. The ranges of the first gas pressure and the second gas pressure listed here are for illustration only, and the disclosure is not limited thereto. Persons in the art may adjust the ranges of the first gas pressure and the second gas pressure according to actual needs. In addition, for the convenience of illustration, the following also represents the first gas pressure as the low-pressure gas and the second gas pressure as the high-pressure gas.

Through using the low-pressure gas to slowly push the liquid toward the spraying head 120 in the second tube 132, not only the shearing force between the cells and the tube wall of the pipe unit 130 may be lessened, preventing cell damage, but also the survival rate of the cells in the pipe unit 130 may be significantly enhanced.

The foregoing pipe unit 130 may be made of Teflon, but the disclosure is not limited thereto. Plastics or other suitable materials may further be selected. In an embodiment, a length range of the pipe unit 130 is between 0.5 and 2 meters, but the disclosure is not limited thereto. In addition, in an embodiment, a volume of the gas provided by the gas pressure source 110 is between 0.25 and 1 ml, but the disclosure is not limited thereto. The volume of the gas is related to a length and a tube diameter of the pipe unit 130. The gas volume, etc. provided by the gas pressure source 110 may be changed according to actual needs.

The volume of the gas provided by the gas pressure source 110 is related to the length of the pipe unit 130. In other words, when the length of the pipe unit 130 changes, the volume of the gas provided by the gas pressure source 110 to the pipe unit 130 also changes accordingly.

Incidentally, the volume of the gas provided by the gas pressure source 110 is further related to an inner diameter of the pipe unit 130, a material of the pipe unit 130, a surface roughness of an inner surface of the pipe unit 130, and the like.

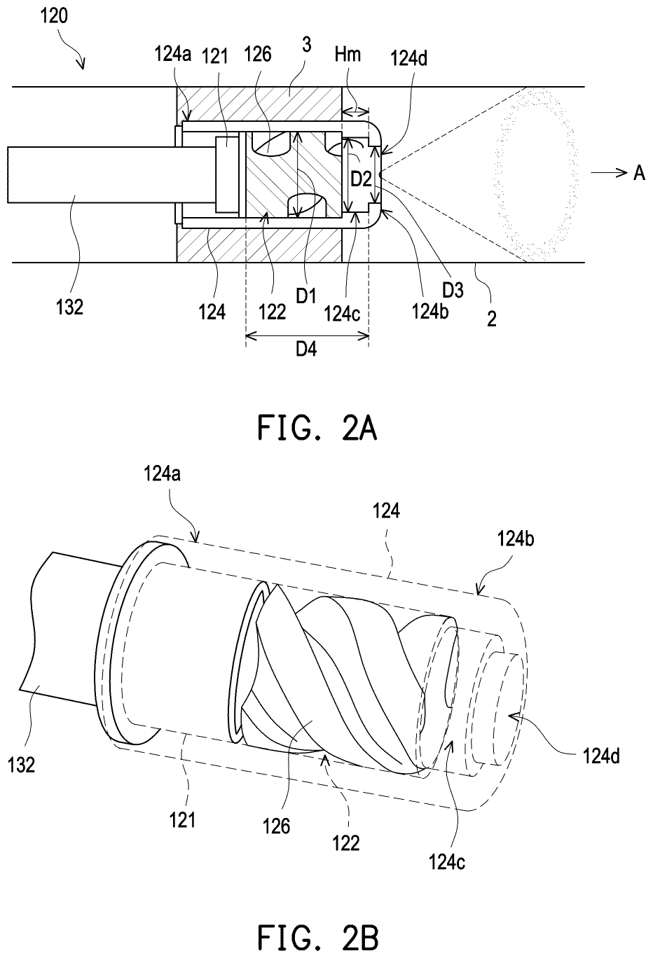

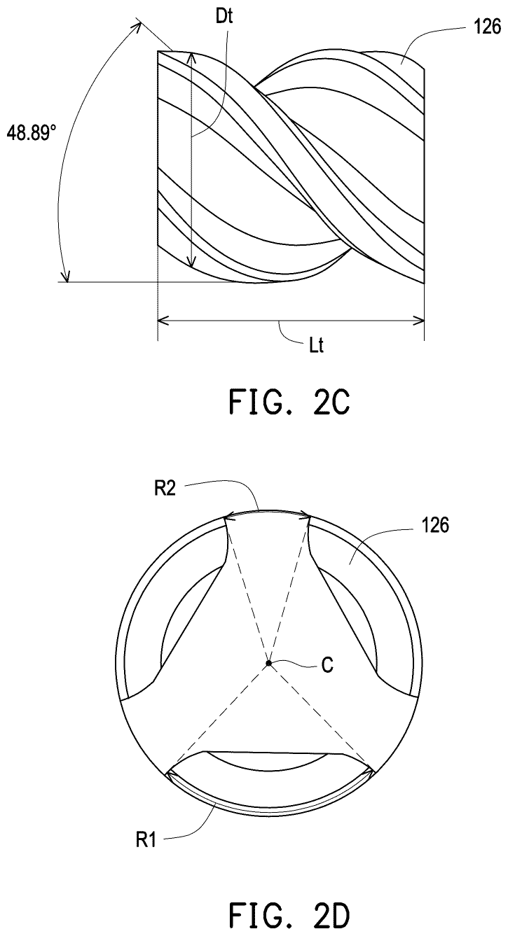

FIG. 2A is a schematic cross-sectional view of the spraying head 120 in the spraying device 100 and the endoscope 3 in FIG. 1 in the inner annular wall 2. FIG. 2B is a perspective schematic view of another perspective of the spraying head 120 in FIG. 2A. Please refer to FIG. 1, FIG. 2A and FIG. 2B at the same time. The spraying head 120 includes a first swirl chamber 122, a fluid outlet 124d, a second swirl chamber 124c, and a turbine 126. The first swirl chamber 122 is in communicating with the pipe unit 130. The second swirl chamber 124c is located between the first swirl chamber 122 and the fluid outlet 124d. The turbine 126 is disposed in the first swirl chamber 122.

Specifically, the spraying head 120 further includes a casing 124. The first swirl chamber 122 and the second swirl chamber 124c are formed on the inside of the casing 124, and the fluid outlet 124d is located at a second end 124b of the casing 124 relatively distant from the second tube 132.

The spraying head 120 further includes an inlet joint 121 disposed in the casing 124, and the inlet joint 121 is disposed at an end of the casing 124 connected to the second tube 132. The inlet joint 121 is configured to secure the turbine 126 in place.

In the embodiment, the inlet joint 121 is annular, and the second tube 132 is sleeved on the inlet joint 121. The inlet joint 121 is assembled to an end of the casing 124 relatively far away from the fluid outlet 124d. It should be noted that the inlet joint 121 is disposed to better allow the second tube 132 to be correspondingly sleeved on the spraying head 120 and position the turbine 126 in the first swirl chamber 122. In another design, the inlet joint 121 may be integrally formed with the casing 124 on the inside of the casing 124 and determined according to needs.

When the liquid enters the spraying head 120 from the second tube 132 of the pipe unit 130, the liquid enters the first swirl chamber 122, passes through the turbine 126, and then is sprayed out from the fluid outlet 124d via the second swirl chamber 124c. In particular, the liquid flowing through the turbine 126 generates multiple swirls due to a centrifugal force caused by threads of the turbine 126. The number of the swirls depends on the quantity of the threads, and the multiple swirls are mixed in the second swirl chamber 124c and then sprayed out in an annular pattern through the fluid outlet 124d.

In the embodiment, please refer to FIG. 2A. A diameter D1 of the first swirl chamber 122 is larger than a diameter D2 of the second swirl chamber 124c, and the diameter D2 of the second swirl chamber 124c is greater than a diameter D3 of the fluid outlet 124d. The diameter D1 of the first swirl chamber 122 is greater than the diameter D2 of the second swirl chamber 124c, which allows the liquid to accelerate into the second swirl chamber 124c and be quickly mixed in the second swirl chamber 124c by the changes of the diameter pressurizing the liquid. The diameter D2 of the second swirl chamber 124c is greater than the diameter D3 of the fluid outlet 124d, which is used to limit an opening angle of the spray when the liquid is sprayed out of the fluid outlet 124d. In addition, the threads of the turbine 126 must rotate at least one full circle to achieve a good spraying effect. The length of the second swirl chamber 124 c is less than ⅓ of the first swirl chamber 122, and an annular spraying effect where the liquid is evenly mixed in the second swirl chamber 124c may be achieved.

In an embodiment, a ratio of an aperture of the fluid outlet 124d to a total length D4 of the first swirl chamber 122 and the second swirl chamber 124 c is between 0.4 and 1. When the ratio is less than 0.4, the pressure when the liquid is sprayed is too high, and the cells in the liquid may be easily damaged. When the ratio is greater than 1, the turbine 126 may fall out of the fluid outlet 124d. Therefore, it can be seen that the foregoing ratio allows the fluid outlet 124d to be large enough to reduce the pressure of the liquid flowing through the fluid outlet 124d. In addition to allowing the liquid to be sprayed out as an annular spray, the survival rate of the cells in the liquid may be further improved after the liquid is sprayed out, avoiding cell death due to a high pressure.

In the embodiment, please refer to FIG. 2A. In order to ensure that the mist particles of the liquid that is sprayed out have appropriate sizes, the diameter D2 of the second swirl chamber 124c is designed to be greater than a length Hm of the second swirl chamber 124c. For example, a ratio of the diameter D2 to the length Hm of the second swirl chamber 124c ranges from approximately 1.6 to 3.8. In an embodiment, the diameter D2 of the second swirl chamber 124 c is approximately 1.12 mm, and the length Hm is approximately 0.5 mm. The ratio of the diameter D2 to the length Hm is 2.24.

In an embodiment, in order to smoothly pass through a working channel of the endoscope and being limited by a corner of the endoscope 3, a length Lt of the turbine 126 in the spraying head 120 is the shorter the better, but the threads of the turbine 126 need to have more than two circles to ensure the spraying airflow, and the diameter of the spraying head 120 may not be too large and other factors, so that an appropriate ratio of a diameter Dt of the turbine 126 to the length Lt is approximately 0.8 to 1.0. In an embodiment, the diameter Dt of the turbine 126 ranges from approximately 1.12 mm, and the length Lt is approximately 1.28 mm. The ratio of the diameter Dt to the length Lt of the turbine 126 is 0.875.

In addition, the casing 121 of the spraying head 120 and the turbine 126 disposed in the first swirl chamber 122 may be made of stainless steel, but the disclosure is not limited thereto. Furthermore, in order to improve cell survivability and liquid spraying efficiency, the inner walls of the first swirl chamber 122 and the second swirl chamber 124c of the spraying head 120 and the surface of the turbine 126 may be further coated with a biocompatible and low-friction coating. The material of the coating is, for example, parylene, PEDOT:PSS, etc. Parylene has a long-lasting protection against enzymes, body fluids, lipids and proteins, etc. and has excellent barrier properties such as corrosion resistance and chemical resistance. Therefore, other liquids may be prevented from penetrating from the inner wall of the casing 124. PEDOT is a polymer of EDOT (3,4-ethylenedioxythiophene monomer), and PSS is polystyrene sulfonate, so that PEDOT: PSS has a high conductivity and cell biocompatibility.

FIG. 2C is a partial side view of the turbine 126 depicted in FIG. 2B, and FIG. 2D is a cross-sectional view of the turbine 126 in FIG. 2C along a diameter direction. Please refer simultaneously to FIG. 2A, FIG. 2C and FIG. 2D at the same time. In an embodiment, a curvature of an opening of a spiral groove of the turbine 126 is designed to be approximately 48.89 degrees in a segment of the turbine 126. A length of the segment is a length on an axial direction A of the turbine 126, and the length is approximately 1.28 mm. In addition, a ratio of a curvature R1 of an opening of a spiral groove of the turbine 126 relative to a center C to a curvature R2 of a spiral part of the turbine 126 relative to the center C ranges from 1 and 5.0. For example, an angle corresponding to the curvature R1 of the opening of the spiral groove is 88 degrees, and an angle corresponding to the curvature R2 of the spiral part is 32 degrees. This manner of design allows the curvature R1 of the opening of the spiral groove to be large enough to be able to reduce the pressure of the liquid when passing through the turbine 126, avoiding cell death due to a high pressure, increasing the annular spraying effect, and improving an area of the liquid adhering to the internal tissues of the human body. When the ratio falls below 1, excessive pressure may damage the cells, so that a liquid that contains cells may not be used. When the ratio exceeds 5, the thickness of the wall is too thin, which may compromise the spraying effect.

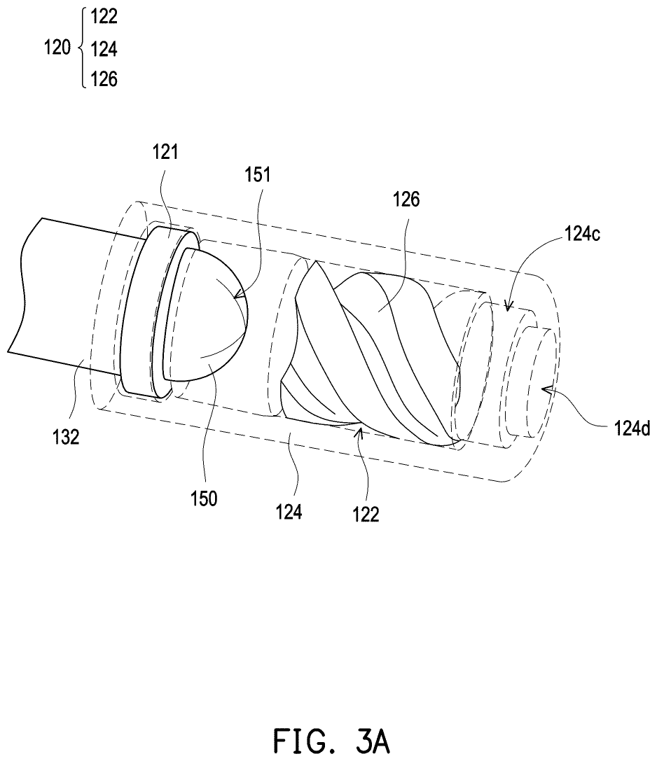

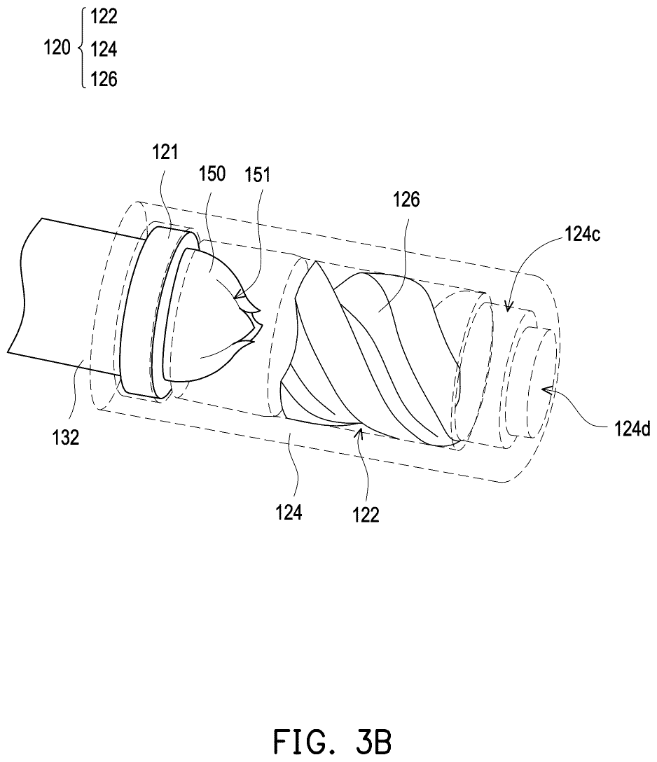

FIG. 3A is a schematic view of the spraying head 120 being further provided with a non-return valve. Please refer to FIG. 3A. In an embodiment, the spraying device 100 further includes a non-return valve 150 disposed at a first end 124a (shown in FIG. 2A) of the casing 124 of the spraying head 120 and connected to the inlet joint 121. The non-return valve 150 may be made of silicone, but the disclosure is not limited thereto. The disposal of the non-return valve 150 may prevent cell leakage during a low-pressure pre-injection of gas, thereby increasing the cell recovery rate, and prevent external body fluids from flowing back into the pipe unit 130 during a high-pressure spraying of liquid to avoid contaminating the pipe unit 130 and increase the survival rate of the cells in the pipe unit 130.

In an embodiment, the non-return valve 150 is constructed from flexible materials and is generally arc-shaped. A top of the arc shape is provided with a cut 151. The shape of the cut 151 may be a straight line, a cross-like shape or other suitable shapes. The cut 151 of the non-return valve 150 of the embodiment is a cross-like shape.

The non-return valve 150 is linked to the gas pressure source 110 and generates a deformation due to the gas pressure source 110 pumping a gas to spray the liquid into the first swirl chamber 122 through the cut 151.

FIG. 3B is a schematic view of a deformation of a non-return valve caused by a gas pressure source pumping a gas. When the gas pressure source 110 pumps a low-pressure gas, the non-return valve 150 is slightly deformed, and the gas may slowly leak out from the cut 151 of the non-return valve 150, as shown in FIG. 3A. When the liquid enters the inlet joint 121 of the spraying head 120, and the gas pressure source 110 pumps a high-pressure gas, the non-return valve 150 is affected by the high-pressure gas and has a larger amount of deformation, and the liquid is sprayed out into the first swirl chamber 122 from the cut 151, as shown in FIG. 3B.

Incidentally, a leading edge of the non-return valve 150 and the turbine 126 need to be spaced by a certain distance so that the liquid may smoothly flow into the threads of the turbine 126. The distance between the leading edge of the non-return valve 150 and the turbine 126 is at least approximately 1 mm.

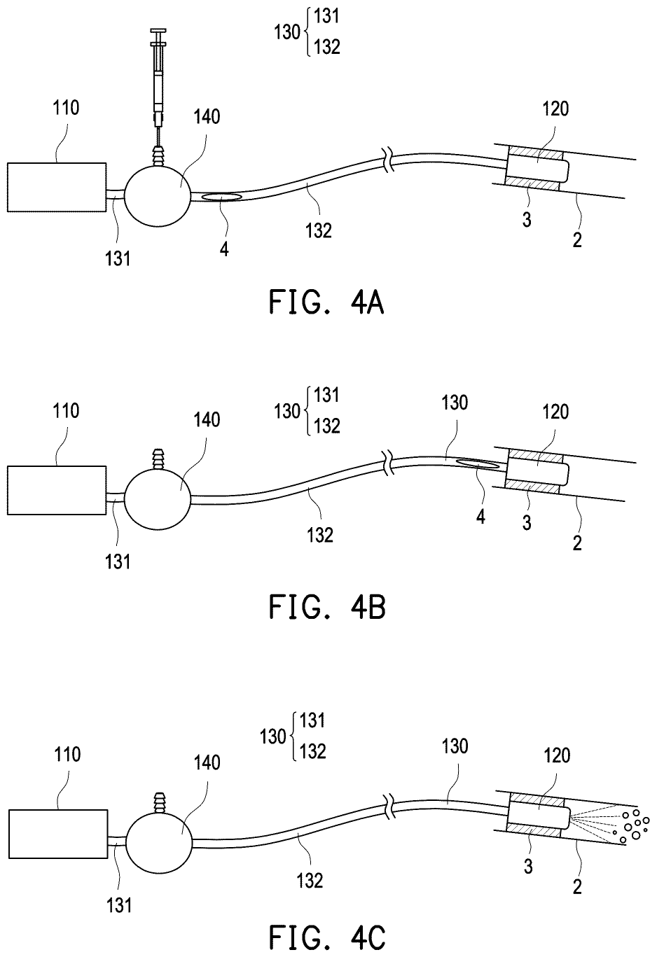

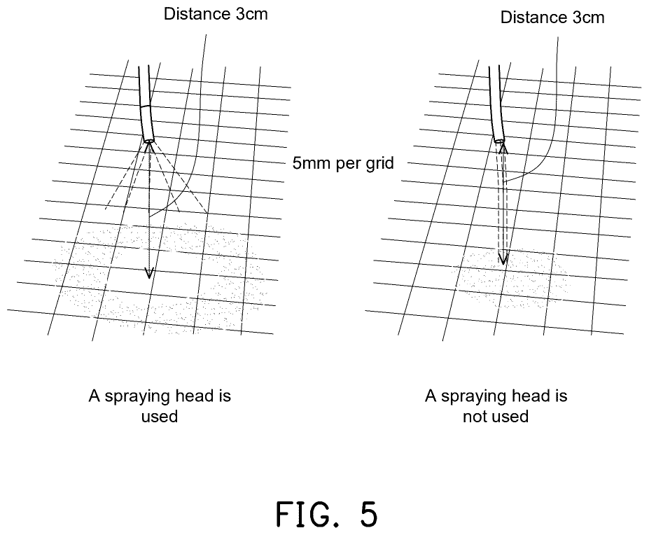

FIG. 4A to FIG. 4C are schematic views of using the spraying device in FIG. 1 to implement a spraying method. As shown in FIG. 4A, when the foregoing spraying device 100 is utilized for the spraying method, approximately 0.25 ml of a liquid 4 is injected into the pipe unit 130 through the tube joint 140.

Next, as shown in FIG. 4B, the gas pressure source 110 is allowed to provide 0.5 ml of the low-pressure gas to propel the liquid 4 in the pipe unit 130 to allow the liquid 4 to slowly move forward toward the direction of the spraying head 120. In the embodiment, a pressure value of the first gas pressure ranges from 0 and 10 kPa.

In an embodiment, the first gas pressure (the low-pressure gas) is provided to move the liquid 4 that contains cells to allow the residual liquid on the tube wall of the pipe unit 130 to be less than the residual liquid on the tube wall where the low-pressure gas is not used to move the liquid 4 that contains cells in the pipe unit 130. In addition, through providing the low-pressure gas to move the liquid 4 that contains cells, the survival rate and recovery rate of the cells are better than the survival rate and recovery rate of the liquid 4 where the low-pressure gas is not used to move the liquid 4 that contains cells in the pipe unit 130.

Next, as shown in FIG. 4C, when the liquid 4 reaches to the spraying head 120, the gas pressure source 110 supplies the second gas pressure (the high-pressure gas) between 50 and 150 KPa to spray the liquid 4 out of the spraying head 120.

In an embodiment, the foregoing structural design of the spraying head 120 allows the spraying effect of the liquid to be good, avoiding the liquid to drip out in a form of water droplets.

FIG. 5 is a comparison of a diagram of a spraying profile which is sprayed by the spraying device 100 in FIG. 1 and a diagram of a spraying profile which is sprayed by the conventional spraying device 100. As shown in FIG. 5 that in a condition where the spraying head 120 is not used in the spraying device 100, the liquid is directly ejected, so the spraying range is smaller, forming a spraying profile with an outer ring diameter less than 3 mm. In a condition where the spraying head 120 is used in the spraying device 100 of the disclosure, an annular spraying profile with an outer ring diameter of approximately 25 mm may be formed, being more adapted to scenarios where an annular spraying needs to be performed, such as gas ducts, gastrointestinal tracts, etc. and increasing the range where the liquid is sprayed on the affected part. In an embodiment, the opening angle of the liquid sprayed from the fluid outlet 124d by the spraying device 100 of the disclosure ranges from 40 and 70 degrees.

In addition, a cell survival rate and a recovery rate after spraying, and a cell survival rate after 16 to 18 hours of culture are verified by applying high-pressure gases at different pressures during spraying.

Specifically, the liquid that contains cells is respectively sprayed out with high-pressure gases of 100 kPa and 80 kPa, and a high-pressure gas (such as air) is applied twice within 6 seconds, and a first cell survival rate and a cell recovery rate in the liquid that has been sprayed out are observed.

In order to further evaluate the damage caused by a high-pressure spraying to cells, the liquid that is sprayed out is cultured for 16 to 18 hours. After the culture is ended, a cell surviving quantity is calculated through a cell fluorescence counter and compared with a quantity of cells before spraying to obtain a second cell survival rate.

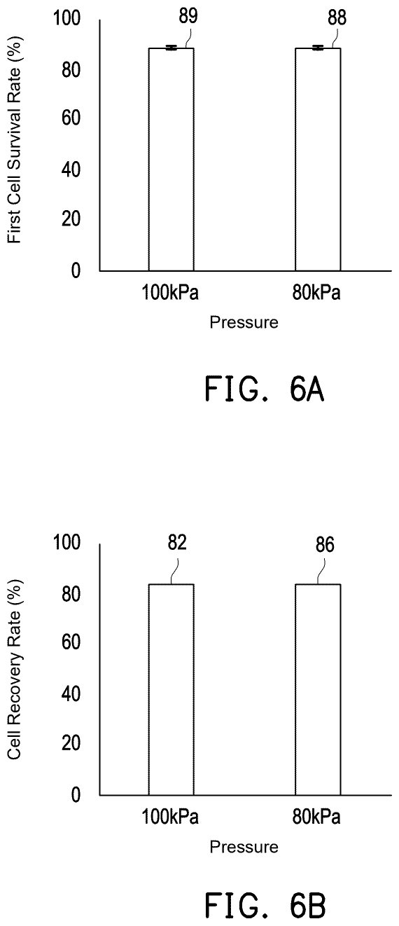

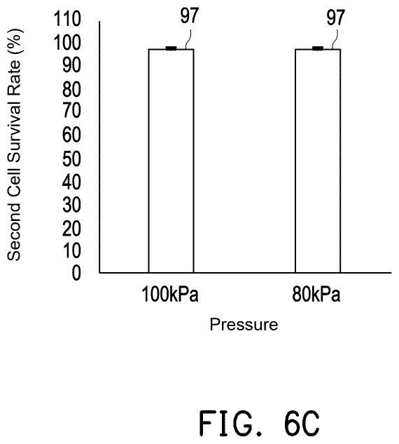

FIG. 6A is a comparative schematic view of first cells survival rates after cells in a liquid are sprayed using different high-pressure gases. As shown in FIG. 6A, a cell survival rate before spraying may reach 91.5%, and the first cell survival rates where high-pressure gases of 100 kPa and 80 kPa are respectively used for spraying remain greater than 88%.

FIG. 6B is a comparative schematic view of recovery rates after cells in a liquid are sprayed using different high-pressure gases. As shown in FIG. 6B, the cell recovery rates where high-pressure gases of 100 kPa and 80 kPa are respectively used for spraying are greater than 82%.

FIG. 6C is a schematic view of second survival rates after cells in a liquid are sprayed out and then cultured. As shown in FIG. 6C, after high-pressure gases of 100 kPa and 80 kPa are applied for spraying, and the cells are cultured for 16 to 18 hours, survival rates of second cells remain greater than 97%.

From the above, it can be seen that using the spraying device 100 of the disclosure to perform an annular spraying effectively avoids issues such as poor cell survival rates.

In conclusion, the spraying device provided by the disclosure has a novel structure and offers excellent spraying coverage and cell survival rate. The disclosure may reduce the volume of the liquid needed during implementation and increase the uniformity of adhesion to a treatment area (such as lung tissues), improve the quantity of cells retained on the tube wall of the affected part, and enhance both the spraying and treatment effect.

What is claimed is:

1. A spraying device configured for spraying a liquid onto a region to be sprayed, comprising:
a gas pressure source;
a spraying head, adapted to spray the liquid in an annular pattern; and
a pipe unit, connected between the gas pressure source and the spraying head for providing the liquid to the spraying head;
wherein when the liquid is located within the pipe unit, the gas pressure source provides a first gas pressure to transport the liquid located in the pipe unit to the spraying head;
when the liquid reaches to the spraying head, the gas pressure source provides a second gas pressure to spray the liquid in the annular pattern through the spraying head onto the region to be sprayed.

2. The spraying device according to claim 1, wherein the spraying head comprises:
a first swirl chamber, communicating with the pipe unit;
a fluid outlet;
a second swirl chamber, positioned between the first swirl chamber and the fluid outlet; and
a turbine, disposed within the first swirl chamber.

3. The spraying device according to claim 2, wherein a ratio of a diameter of the fluid outlet to a total length of the first swirl chamber and the second swirl chamber is between 0.4 and 1.

4. The spraying device according to claim 2, wherein a diameter of the first swirl chamber is greater than a diameter of the second swirl chamber, and the diameter of the second swirl chamber is greater than a diameter of the fluid outlet.

5. The spraying device according to claim 2, wherein a ratio of a curvature of an opening of a spiral groove of the turbine to a curvature of a spiral part of the turbine is between 1 and 5.0.

6. The spraying device according to claim 2, further comprising a non-return valve, positioned at an end of the spraying head relatively proximal to the pipe unit, wherein the non-return valve is located between the turbine and the pipe unit.

7. The spraying device according to claim 6, wherein an opening and a closing of the non-return valve are linked to the gas pressure source.

8. The spraying device according to claim 1, wherein a pressure value of the first gas pressure is lower than a pressure value of the second gas pressure.

9. The spraying device according to claim 8, wherein the pressure value of the first gas pressure is between 0 and 10 kPa, and the pressure value of the second gas pressure is between 50 and 200 KPa.

10. The spraying device according to claim 1, wherein the liquid comprises cells or medicines.

11. The spraying device according to claim 1, further comprising a tube joint, wherein the pipe unit comprises a first tube and a second tube, the first tube is communicating with the gas pressure source, the second tube is connected to the spraying head, and the tube joint is communicated between the first tube and the second tube, and the liquid is adapted to enter the pipe unit through the tube joint.

12. The spraying device according to claim 11, wherein the tube joint is a three-way tube or a directional valve.

13. A spraying method, adapted to spray a liquid onto a region to be sprayed, comprising:
providing the spraying device according to claim 1;
injecting a liquid into the pipe unit;
wherein when the liquid is located in the pipe unit, the gas pressure source provides a first gas pressure to transport the liquid located in the pipe unit to the spraying head; and
when the liquid is reaches to the spraying head, the gas pressure source provides a second gas pressure to spray the liquid in an annular pattern through the spraying head to the region to be sprayed.

14. The spraying method according to claim 13, wherein an amount of the liquid injected into the pipe unit ranges from 0.1 to 2 ml.

15. The spraying method according to claim 13, wherein a pressure value of the first gas pressure is lower than a pressure value of the second gas pressure.

16. The spraying method according to claim 15, wherein the pressure value of the first gas pressure is between 0 and 10 kPa, and the pressure value of the second gas pressure is between 50 and 200 kPa.

17. The spraying method according to claim 13, wherein the liquid comprises cells or medicines.

18. The spraying method according to claim 13, further comprising positioning a non-return valve at an end of the spraying head proximal to the pipe unit, wherein the non-return valve is located between a turbine of the spraying head and the pipe unit to prevent the liquid from flowing back into the pipe unit.

19. The spraying method according to claim 18, wherein an opening and a closing of the non-return valve are linked to the gas pressure source.
